(19) United States
(12) Patent Application Publication
(10) Pub. No.: US 2026/0311357 A1
(43) Pub. Date: Oct. 8, 2026

(54) METHOD AND APPARATUS FOR DETERMINING WIDTH OF VIEWPOINT

(71) Applicant: FUTURE TECHNOLOGY (XIANGYANG) CO., LTD., Xiangyang City, Hubei (CN)

(72) Inventors: Shu He, Xiangyang City, Hubei (CN); Wanliang Xu, Xiangyang City, Hubei (CN)

(21) Appl. No.: 19/119,173

(22) PCT Filed: Sep. 8, 2022
(86) PCT No.: PCT/CN2022/117710

§ 371 Date: Apr. 8, 2025

(30) Foreign Application Priority Data
Sep. 8, 2021 (CN) 202111049335.9

(51) Int. Cl. G06T 7/60; G01B 11/00; G01B 11/04; G06T 7/00; G06T 7/73

(52) U.S. Cl. CPC G06T 7/60; G01B 11/002; G01B 11/046; G06T 7/75; G06T 7/97; G06T 2207/10012

(57) ABSTRACT

Described herein are a method for determining widths of viewpoints and related devices, the method includes: displaying a target image for a second device to shoot to obtain two groups of images, segmenting two images in each group of images to obtain four regions, and calculating a first average difference of pixels between two regions and a second average difference of pixels between other two regions; recording first location coordinates where the second device captures the first group of images when the first average difference of pixels reaches a first preset value; recording second location coordinates where the second device captures the second group of images when the second average difference of pixels reaches a second preset value; and determining a width of a viewpoint of the first device according to the first and second location coordinates and an application angle of a grating of the first device.

### TECHNICAL FIELD

The present application relates to the field of naked-eye 3D, and in particular to a method for determining widths of viewpoints and a device thereof.

### BACKGROUND

Naked-eye 3D, short for “Autostereoscopy”, is a general term for technologies that achieve stereoscopic visual effects without tools such as the polarized glasses.

In a naked-eye 3D system with human eye tracking, the device collects images through the front camera and tracks the location of the human eyes, and calculates the viewpoint corresponding to the current location of the human eyes. The width of each viewpoint in the naked-eye 3D system needs to be determined during the process of image collection through the front camera and human eye tracking.

At present, the widths of the viewpoints are mainly deduced through optical design, but in actual use, gratings of one type are often applied to a variety types of third-party devices, and it is impossible to obtain the exact optical parameters of the screens of those devices, such as the thickness of the glasses and the thickness of the optical glue, and the sizes of the gaps between the gratings and the screens, etc., which leads to the inability to accurately determine the widths of the viewpoints.

### SUMMARY

The purpose of the present application is to provide a method and a device for determining widths of viewpoints, which can quickly determine a width of a viewpoint corresponding to a device when optical parameters of a screen of the device are unknown, and then adjust the 3D images or 3D videos displayed by the device according to the width of the viewpoint to improve viewing experience of users.

A first aspect of the embodiments of the present application provides a method for determining widths of viewpoints, which includes:
displaying, by a first device, a target image in a stereoscopic mode, for a second device to shoot the target image in real time to obtain a first group of images and a second group of images, and divide two images in the first group of images and two images in the second group of images to obtain a first region, a second region, a third region and a fourth region, and calculate a first average difference of pixels between the first region and the second regions and a second average difference of pixels between the third region and the fourth region, the first group of images and the second group of images being obtained by the second device which shoots, at different locations, the target image through synchronous shooting of two cameras of the second device, the two cameras of the second device being on a same horizontal line, and centers of the two cameras of the second device being spaced away for a preset distance, the first region and the second region corresponding to the two images of the first group of images, and the third region and the fourth region corresponding to the two images of the second group of images;
recording, by the first device, first location coordinates at which the second device captures the first group of images, in responding to a first coordinate recording instruction received by the first device from the second device, the first coordinate recording instruction being issued in responding to that the first average difference of pixels reaches a first preset value;
recording, by the first device, second location coordinates at which the second device captures the second group of images, in responding to a second coordinate recording instruction received by the first device from the second device, the second coordinate recording instruction being issued in responding to that the second average difference of pixels reaches a second preset value;
determining, by the first device, a width of a viewpoint corresponding to the first device according to the first location coordinates, the second location coordinates and an application angle of a grating corresponding to the first device.

A second aspect of the embodiments of the present application provides a method for determining widths of viewpoints, which includes:
shooting in real time, by a second device, a target image displayed in stereoscopic mode by a first device, to obtain a first group of images and a second group of images, the first group of images and the second group of images being obtained by the second device which shoots, at different locations, the target image through synchronous shooting of two cameras of the second device, and the two cameras of the second device being on a same horizontal line, and centers of the two cameras being spaced away for a preset distance;
segmenting, by the second device, two images in the first group of images and two images in the second group of images to obtain a first region, a second region, a third region and a fourth region, the first region and the second region corresponding to the two images in the first group of images, and the third region and the fourth region corresponding to the two images of the second group of images;
calculating, by the second device, a first average difference of pixels between the first region and the second region and a second average difference of pixels between the third region and the fourth region;
sending, by the second device, a first coordinate recording instruction to the first device in responding to that the first average difference of pixels reaches a first preset value, to cause the first device to record a first coordinate location, the first location coordinates being coordinates of a location of the second device when capturing the first group of images;
sending, by the second device, a second coordinate recording instruction to the first device in responding to that the second average difference of pixels reaches a second preset value, to cause the first device to record second location coordinates and determine a width of a viewpoint corresponding to the first device according to the first location coordinates, the second location coordinates and an application angle of a grating corresponding to the first device, the second location coordinates being coordinates of another location of the second device when capturing the second group of images.

A third aspect of the embodiments of the present application provides a device for determining widths of viewpoints, which includes a first device, and the first device includes:
a display unit, configured to display a target image in a stereoscopic mode for the second device to shoot in real time to obtain a first group of images and a second group of images, segment two images of the first group of images and two images of the second group of images to obtain a first region, a second region, a third region and a fourth region, and calculate a first average difference of pixels between the first region and the second regions and a second average difference of pixels between the third region and the fourth region, the first group of images and the second group of images being obtained by the second device which shoots, at different locations, the target image through synchronous shooting of two cameras of the second device, the two cameras of the second device being on the same horizontal line, and centers of the two cameras of the second device being spaced away for a preset distance, the first region and the second region corresponding to the two images of the first group of images, and the third region and the fourth region corresponding to the two images of the second group of images;
a recording unit, configured for the first device to record first location coordinates where the second device captures the first group of images in responding to a first coordinate recording instruction received from the second device by the first device, and record second location coordinates where the second device captures the second group of images in responding to a second coordinate recording instruction from the second device by the first device, the first coordinate recording instruction being issued in responding to that the first average difference of pixels reaches a first preset value, and the second coordinate recording instruction being issued in responding to that the second average difference of pixels reaches a second preset value;
a determining unit, configured to determine a width of a viewpoint corresponding to the first device according to the first location coordinates, the second location coordinates, and an application angle of the grating corresponding to the first device.

Compared with related art, in the embodiments provided in this application, in the embodiments provided in this application, when to determine the width of the viewpoint of the first device, the second device can capture multiple images of the first device at different locations, segment the multiple images to obtain two image regions, and calculate the average difference of pixels between the two image regions. When the average difference of pixels reaches a preset value, the first device records the location coordinates of the second device at that time point, and then calculates the width of the viewpoint corresponding to the first device according to the location coordinates of the second device at different locations and the application angle of the grating. Thus, even when the optical parameters of the screen of the first device are unknown, the width of the viewpoint corresponding to the first device can be quickly determined, the 3D images or 3D videos displayed by the first device can be adjusted according to the width of the viewpoint, and the user viewing experience is improved.

### BRIEF DESCRIPTION OF FIGURES

FIG. 1 is a functional block diagram of a location indicator in the related art.

FIG. 2 is the structural block diagram of a location detection system provided by the present application.

FIG. 3 is a structural block diagram of a key detection circuit shown in FIG. 2.

FIG. 4 is a structural block diagram of a pressure detection circuit shown in FIG. 2.

FIG. 5 is a schematic diagram of a data communication transmission benchmark of a digital stylus.

FIG. 6 is a schematic diagram of data communication between a digital stylus and a tablet.

### DETAILED DESCRIPTION

The embodiments of the present application will be clearly and completely described below with reference to the drawings in the embodiments of the present application. Obviously, the described embodiments are only some, not all of the embodiments of the present application.

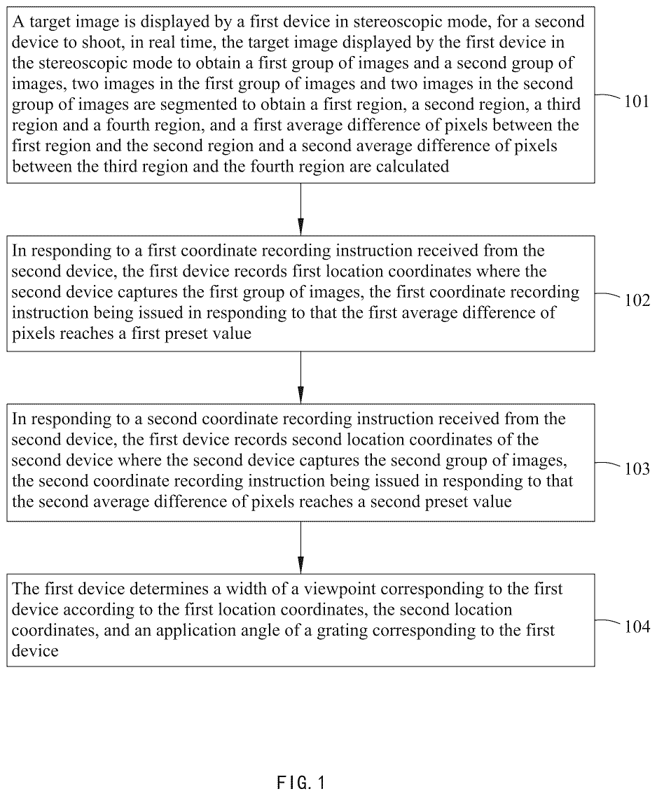

Referring to FIG. 1, FIG. 1 is a schematic diagram of a method for determining a width of a viewpoint according to an embodiment of the present application, which includes:

operation 101, a target image is displayed by a first device in stereoscopic mode, for a second device to shoot, in real time, the target image displayed by the first device in the stereoscopic mode to obtain a first group of images and a second group of images, two images in the first group of images and two images in the second group of images are segmented to obtain a first region, a second region, a third region and a fourth region, and a first average difference of pixels between the first region and the second region and a second average difference of pixels between the third region and the fourth region are calculated.

In this embodiment, the first group of images and the second group of images are obtained by the second device which shoots, at different locations, the target image through synchronous shooting of two cameras of the second device. The two cameras of the second device are on the same horizontal line, centers of the two cameras of the second device are spaced away for a preset distance. The first region and the second region correspond to the two images of the first group of images one to one, and the third region and the fourth region correspond to the two images of the second group of images one to one. The second device can be any terminal device which has an image acquisition function and a communication function. One half of the target image is black and the other half of the target image is colored with visible colors such as white, red, green, and yellow. It can be understood that the second device shoots the target image to obtain the first group of images and the second group of images, each image of the first group of images and the second group of images may not only contain the target image, but also include other content, thus what needs to be determined are the average differences of pixels between screen regions, not the average differences of pixels between the images. Each screen region is a part of the screen of the first device and is occupied by the target image. In addition, not only the target image, the first device may also display location coordinates of the second device, or location coordinates of the cameras of the second device in real time on the screen of the first device.

Operation 102, in responding to a first coordinate recording instruction received from the second device, the first device records first location coordinates where the second device captures the first group of images, the first coordinate recording instruction being issued in responding to that the first average difference of pixels reaches a first preset value.

In this embodiment, after the second device divides the first group of images to obtain the first region and the second region, and calculates the first average difference of pixels between the first region and the second region, whether the first average difference of pixels reaches the first preset value can be determined. In respond to that the first average difference of pixels reaches the first preset value, the second device sends the first coordinate recording instruction to the first device, and the first device records, according to the first coordinate recording instruction, the first location coordinates of the second device at which the second device captures the first group of images.

Operation 103, in responding to a second coordinate recording instruction received from the second device, the first device records second location coordinates of the second device where the second device captures the second group of images, the second coordinate recording instruction being issued in responding to that the second average difference of pixels reaches a second preset value.

In this embodiment, after the second device divides the second group of images to obtain the third region and the fourth region, and calculates the second average difference of pixels between the third region and the fourth region, whether the second average difference of pixels reaches the second preset value can be determined. In responding to that the second average difference of pixels reaches the second preset value, the second device sends the second coordinate recording instruction to the first device, and the first device records, according to the second coordinate recording instruction, the second location coordinates of the second device at which the second device captures the second group of images.

Operation 104, the first device determines a width of a viewpoint corresponding to the first device according to the first location coordinates, the second location coordinates, and an application angle of a grating corresponding to the first device.

In this embodiment, after the first location coordinates and the second location coordinates are recorded, the first device can acquire the application angle of the grating corresponding to the first device (namely the application angle of a 3D film grating pasted on the first device, furthermore, how to acquire the application angle of the grating is not limited here, for example, the application angle can be input by a user), and determine the width of the viewpoint corresponding to the first device according to the first location coordinates, the second location coordinates and the application angle.

In an embodiment, the first device determining the width of the viewpoint corresponding to the first device according to the first location coordinates, the second location coordinates, and the application angle of the grating corresponding to the first device includes:
the first device determining a first location of the second device according to the application angle and the first location coordinates, the first location being where the second device locates when the first average difference of pixels reaches the first preset value;
the first device determining a second location of the second device according to the application angle and the second location coordinates, the second location being where the second device locates when the second average difference of pixels reaches the second preset value;
the first device determining the width of the viewpoint based on the first location and the second location.

In this embodiment, the first location is where the second device locates to capture the first group of images when the first average difference of pixels reaches the first preset value, and the first device may calculate the first location according to the following formula based on the application angle and the first location coordinates:

$${X}_{0}^{′} = {x}_{0} + ( {y}_{0} - y ) * tan ( a )$$

where

$${X}_{0}^{′}$$

represents the first location, the first location coordinates are (x₀, y₀), y is a preset constant, and a is the application angle.

The second location is where the second device locates to capture the second group of images when the second average difference of pixels reaches the second preset value, and the first device may calculate the second location according to the following formula based on the application angle and the second location coordinates:

$${X}_{1}^{′} = {x}_{1} + ( {y}_{1} - y ) * tan ( a ) ;$$

where

$${X}_{1}^{′}$$

represents the second location, and the second location coordinates are (x₁, y₁).

After the first location and the second location are calculated according to the formulas, the first device may calculate the width of the viewpoint corresponding to the first device according to the following formula based on the first location and the second location:

$$VW = abs ( {X}_{0}^{′} - {X}_{1}^{′} ) ;$$

where VW represents the width of the viewpoint corresponding to the first device, and abs is an absolute value function.

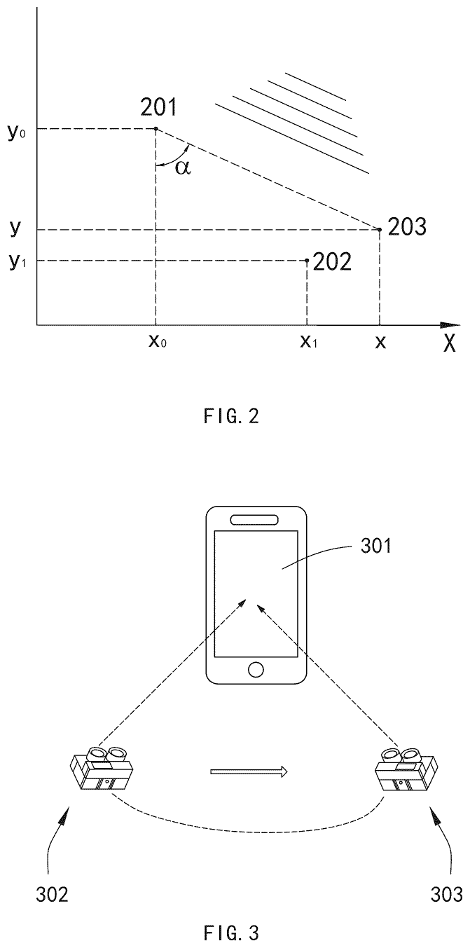

The calculation of the width of the viewpoint will be described below in conjunction with FIG. 2. FIG. 2 is a schematic diagram for illustrating the calculation of the width of the viewpoint provided by an embodiment of the present application. 201 represents the first location coordinates (x₀, y₀), and 202 represents the second location coordinates (x₁, y₁), 203 represents coordinates of a preset constant y in the coordinate system (it can be understood that the preset constant y can be set to half the width of the screen region, and of course the preset constant can be set according to the actual situation, which is not limited here). The calculation of the first location

$${X}_{0}^{′}$$

is taken as an example for illustration. The application angle a of the grating is known when to calculate the first location

$${X}_{0}^{′} .$$

After the first location coordinates (x₀, y₀) are obtained, the preset constant 203 is converted to have the same direction as the Y-axis of the first location coordinates, and then the first location can be calculated according to the formula:

$${X}_{0}^{′} = {x}_{0} + ( {y}_{0} - y ) * tan ( a ) ,$$

the second location can be calculated in the same way, and then an absolute value of the difference between the first location and the second location, namely the width of the viewpoint corresponding to the first device, is calculated according to the formula:

$$VW = abs ( {X}_{0}^{′} - {X}_{1}^{′} ) .$$

It should be noted that after the width of the viewpoint corresponding to the first device is obtained, the first device can adjust 3D images or 3D videos displayed in the stereoscopic mode based on the width of the viewpoint. In an embodiment, when to adjust the 3D images or 3D videos displayed in the stereoscopic mode based on the width of the viewpoint, the first device obtains a width of the grating corresponding to the first device, determines a layout of viewpoints corresponding to the first device according to the width of the grating and the width of the viewpoint, and adjusts the 3D images displayed by the first device according to the layout of the viewpoints and the position changes of the user's eyes. That is to say, after the width of the viewpoint is obtained, since the width of the grating of the first device is known, the layout and arrangement of the 3D film grating pasted on the screen of the first device can be obtained, and then the 3D images or 3D videos in the stereoscopic mode can be adjusted according to the changes in the position of the human eyes, so as to provide users with a better 3D display effect.

It should be noted that in the above embodiment, the location of the second device is changed while the location of the first device remains unchanged, the location coordinates of the cameras of the second device are tracked by the first device, and the changed location coordinates of the second device are recorded. Of course, other ways can be employed, for example, the location of the second device remains unchanged while the location of the first device is changed to record the location coordinates of the cameras of the second device, which is not specifically limited here, it only needs to meet that the second device shoots the first device at different locations and the corresponding different location coordinates can be recorded. It can be understood that if the location of the detector remains unchanged, the coordinates of the human eyes of the detector are recorded by changing the location of the target device, and the execution process thereof is detailed below.

The first device displays the target image in the stereoscopic mode, the second device shoots the first device, and the screen of the first device displays the location coordinates of the second device (or the location coordinates of the cameras of the second device which is not limited here). The location of the first device is adjusted until the first device receives the coordinate recording instruction from the second device. The first device records a current location coordinates of the second device. The coordinate recording instruction is sent by the second device when the images obtained by shooting the first device are analyzed, the corresponding average difference of pixels is obtained, and the average difference of pixels reaches the first preset value or the second preset value. After that, the location of the first device is further adjusted until another coordinate recording instruction is received from the second device, and new current location coordinates of the second device is recorded. The another coordinate recording instruction is sent by the second device when the images obtained by shooting the first device are analyzed, the corresponding average difference of pixels is obtained, and the average difference of pixels reaches the first preset value or the second preset value. Thus, the location coordinates corresponding to two different locations can be obtained, and the width of the viewpoint is calculated according to the location coordinates of the two different locations and the application angle.

In summary, it can be seen that in the embodiments provided by the present application, when to determine the width of the viewpoint of the first device, the second device can capture multiple images of the first device at different locations, segment the multiple images to obtain two image regions, and calculate the average difference of pixels between the two image regions. When the average difference of pixels reaches a preset value, the first device records the location coordinates of the second device at that time point, and then calculates the width of the viewpoint corresponding to the first device according to the location coordinates of the second device at different locations and the application angle of the grating. Thus, even when the optical parameters of the screen of the first device are unknown, the width of the viewpoint corresponding to the first device can be quickly determined, the 3D images or 3D videos displayed by the first device can be adjusted according to the width of the viewpoint, and the user viewing experience is improved.

Referring to FIG. 3, FIG. 3 is a schematic diagram of an application scenario provided by an embodiment of the present application. As shown in FIG. 3, the first device has a fixed location and the second device has a changeable location. The first device records the location coordinates of the second device at a time point that the average difference of pixels between the images taken by the second device reaches a preset value. As shown in FIG. 3, when to determine the width of viewing-point of the 3D film on the first device 301, the first device 301 displays the target image in the stereoscopic mode, and the second device shoots, at different locations, the target image displayed in the stereoscopic mode through two cameras of the second device and obtains images accordingly. The second device divides the images to obtain two image regions, calculates the average difference of pixels between the two image regions, and determines whether the average difference of pixels reaches the first preset value or the second preset value. In responding to that the average difference of pixels reaches the first preset value or the second preset value, the second device sends a coordinate recording instruction to the first device 301. Upon receiving the coordinate recording instruction, the first device 301 records the location coordinates. As shown in FIG. 3, when the second device is at location 302 and the first average difference of pixels between the images of the first device 301 reaches the first preset value, the first device 301 receives the first coordinate recording instruction and records the first location coordinates that corresponds to the location 302 of the second device. After that, the location of the second device is changed, the second device shoots the first device 301 and obtains the images accordingly. The second device divides the images to obtain two image regions, calculates the average difference of pixels between the two image regions, and determines whether the average difference of pixels reaches the second preset value. In responding to that the second average difference of pixels reaches the second preset value, the second device sends the second coordinate recording instruction to the first device 301, and the first device 301 records the second coordinates corresponding to the location 303 of the second device according to the second coordinate recording instruction. Then the first device 301 calculates the width of the viewpoint corresponding to the first device 301 according to the first location coordinates corresponding to the location 301 of the second device, the second location coordinates corresponding to the location 303 of the second device, and the application angle of the grating corresponding to the first device 301, and adjusts the 3D images or 3D videos displayed in the stereoscopic mode according to the width of the viewpoint. Therefore, even when the optical parameters of the screen of the first device are unknown, the width of the viewpoint corresponding to the first device 301 can be quickly determined, the 3D images or 3d videos displayed by the first device 301 can be adjusted according to the width of the viewpoint, and the viewing experience of users is improved.

It should be noted that, the second device is stopped at a location and shoots the first device through the two cameras equipped on the second device to obtain a group of images of the first device, the images are directly segmented to obtain the image regions, and the average difference of pixels between the image regions is calculated. Whether the average difference of pixels reaches the first preset value or the second preset value is determined. If the average difference of pixels does not reach either of the preset values, the second device is moved to other locations, and the above operations are repeated until the average difference of pixels between the images of the first device taken at a certain location reaches the first preset value. After the average difference of pixels reaches the first preset value, the coordinate recording instruction is sent to the first device, so that the first device returns the corresponding location coordinates. After that, the location is adjusted again to perform the above operations until the average difference of pixels between the images of the first device taken at another location reaches the second preset value. The location coordinates of the two locations are obtained from the first device and taken as the first location coordinates and the second location coordinates correspondingly.

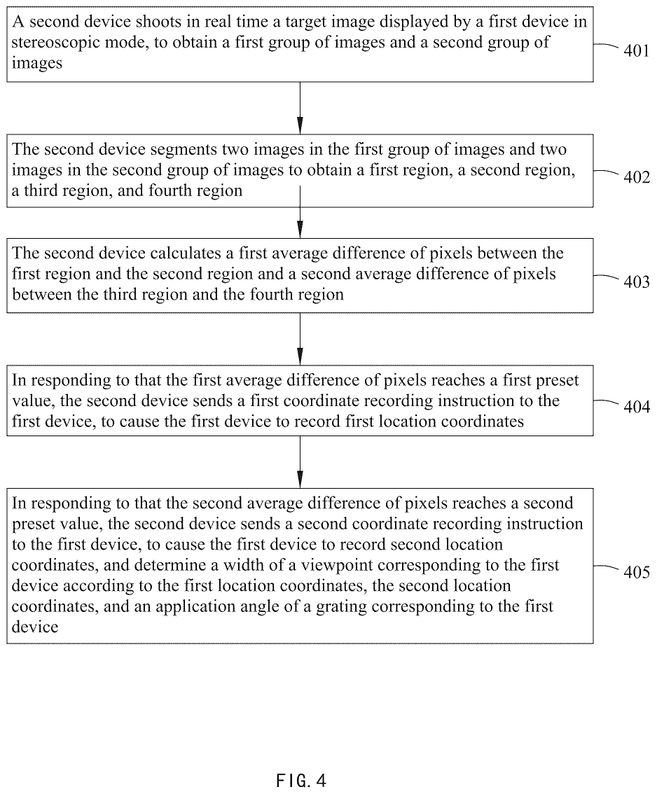

The method for determining the width of the viewpoint provided by embodiments of the present application is described above from the perspective of the first device in conjunction with FIG. 1, and will be further described below from the perspective of the second device in conjunction with FIG. 4.

Referring to FIG. 4, FIG. 4 is a schematic diagram of another embodiment of the method for determining the width of the viewpoint provided by the embodiments of the present application, which includes:

operation 401, a second device shoots in real time a target image displayed by a first device in stereoscopic mode, to obtain a first group of images and a second group of images. In this embodiment, the first group of images and the second group of images are obtained by the second device shooting, at different locations, the target image through the synchronous shooting of two cameras of the second device. The two cameras of the second device are on the same horizontal line, centers of the two cameras of the second device are spaced away for a preset distance, such as 65 mm. The second device can be any terminal device which has an image acquisition function and a communication function. One half of the target image is black, and the other half of the target image is colored with visible colors such as white, red, green, and yellow. That is to say, when to determine the width of the viewpoint corresponding to the first device (that is, the width of the viewpoint corresponding to the 3D film covered on the screen of the target device), the first device displays the image whose one half is black and the other half is colored in the 3D mode, and the second device takes pictures of the first device at different locations to obtain the first group of images and the second group of images.

Operation 402, the second device segments two images in the first group of images and two images in the second group of images to obtain a first region, a second region, a third region, and fourth region.

In this embodiment, after the first group of images and the second group of images are obtained, the second device can segment two images in the first group of images to obtain the first region and the second region, and segment two images in the second group of images to obtain the third region and the fourth region. That is, the two cameras of the second device are used to capture the target image, each image captured by each camera will include other content besides the target image. The segmentation of the images is to ensure that the first region, the second region, the third region and the fourth region include only the target image, and do not include other content.

Operation 403, the second device calculates a first average difference of pixels between the first region and the second region and a second average difference of pixels between the third region and the fourth region.

In this embodiment, the second device divides the first group of images and the second group of images to obtain the first region, the second region, the third region and the fourth region, and calculates the first average difference of pixels between the first region and the second region and the second average difference of pixels between the third region and the fourth region. In an embodiment, the second device may calculate the first average difference of pixels and the second average difference of pixels according to the following formula:

$$aver\_pixel = {\sum }_{j = 0}^{w} {\sum }_{j = 0}^{h} abs ( Al ( i , j ) - Ar ( i , j ) ) / ( w * h )$$

where aver_piexl represents the first average difference of pixels or the second average difference of pixels, A represents the screen region, Al represents the first region or the third region, Ar represents the second region or the fourth region, w is a width of the first region or a width of the third region, h is a height of the second region or a height of the fourth region, the first region and the second region have the same width and the same height, and the third region and the fourth region have the same width and the same height.

It can be understood that the second device shoots the target image to obtain the first group of images and the second group of images, the first group of images and the second group of images may not only contain the target image, but also include other content, thus what needs to be determined are the average differences of pixels between screen regions, not the average differences of pixels between the images. Each screen region is a part, which is occupied by the target image, of the screen of the first device. In addition, not only the target image, the first device may also display location coordinates of the second device, or location coordinates of the cameras of the second device in real time on the screen of the first device.

Operation 404, in responding to that the first average difference of pixels reaches a first preset value, the second device sends a first coordinate recording instruction to the first device, to cause the first device to record first location coordinates.

In this embodiment, after the first group of images are analyzed and the first average difference of pixels are obtained, the second device determines whether the first average difference of pixels reaches the first preset value. In a condition that the first average difference of pixels reaches the first preset value, the second device sends the first coordinate recording instruction to the first device, to cause the first device to record the first location coordinates. The first location coordinates are the coordinates of the location of the second device when capturing the first group of images. That is to say, the first device displays the location coordinates of the second device in real time, when the second device determines that the first average difference of pixels reaches the first preset value, the second device sends the first coordinate recording instruction to the first device, and upon receiving the first coordinate recording instruction, the first device records the location coordinates of the second device where the first group of images are taken.

It can be understood that, in a condition that the first average difference of pixels does not reach the first preset value, the second device changes its location, shoots the first device again to obtain new images, and analyzes the new images until the average differences of pixels of the new images reaches the first preset value, and then the second device sends the first coordinate recording instruction to the first device, to cause the first device to record the location coordinates of the location.

Operation 405, in responding to that the second average difference of pixels reaches a second preset value, the second device sends a second coordinate recording instruction to the first device, to cause the first device to record second location coordinates, and determine a width of a viewpoint corresponding to the first device according to the first location coordinates, the second location coordinates, and an application angle of a grating corresponding to the first device.

In this embodiment, after the second group of images is analyzed and the second average difference of pixels is obtained, the second device determines whether the second average difference of pixels reaches the second preset value. In a condition that the second average difference of pixels reaches the second preset value, the second device sends the second coordinate recording instruction to the first device, to cause the first device to record the second location coordinates, and determine the width of the viewpoint corresponding to the first device according to the first location coordinates, the second location coordinates, and the application angle of the grating corresponding to the first device. The second location coordinates are the coordinates of the location of the second device when capturing the second group of images. That is to say, the first device displays the location coordinates of the second device in real time, when the second device determines that the second average difference of pixels reaches the second preset value, the second device sends the second coordinate recording instruction to the first device, and upon receiving the second coordinate recording instruction, the first device records the location coordinates of the location, and calculates the width of the viewpoint according to the two sets of location coordinates and the application angle.

It can be understood that, in a condition that the second average difference of pixels does not reach the second preset value, the second device changes its location and shoots the first device again to obtain new images, and analyzes the new image until the average differences of pixels of the new images reaches the second preset value, and then the second device sends the second coordinate recording instruction to the first device, to cause the first device to record the location coordinates of the location.

It should be noted that, after the second device is stopped at a location and captures the first device to obtain the images of the first device, the second device directly analyzes the images to obtain the corresponding average difference of pixels, and determines whether the average difference of pixels reaches the first preset value or the second preset value. If the average difference of pixels does not reach either of the preset values, the second device is moved to other locations and the above operations are repeated until the average difference of pixels between the images of the first device taken at a certain location reaches the first preset value. After the average difference of pixels reaches the first preset value, the first coordinate recording instruction is sent to the first device to cause the first device to record the corresponding location coordinates. After that, the location is adjusted again to perform the above operations until the average difference of pixels between the images of the first device taken at another location reaches the second preset value. The second coordinate recording instruction is sent to the first device, so that the first device records the coordinates of the location, and calculates the width of the viewpoint according to the coordinates of the two locations and the application angle.

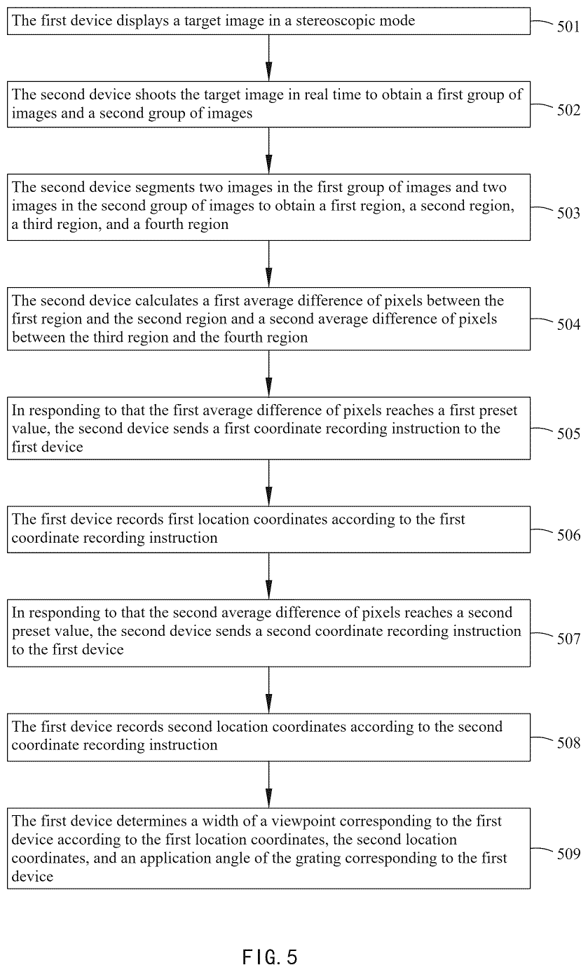

The method for determining the width of the viewpoint provided by embodiments of the present application is described above from the perspectives of the second device and the first device, and will be further described below from the perspective of interaction between the first device and the second device in conjunction with FIG. 5.

Referring to FIG. 5, FIG. 5 is a schematic diagram of another embodiment of the method for determining the width of the viewpoint provided by the embodiments of the present application, which includes:

operation 501, the first device displays a target image in a stereoscopic mode.

Operation 502, the second device shoots the target image in real time to obtain a first group of images and a second group of images.

Operation 503, the second device segments two images in the first group of images and two images in the second group of images to obtain a first region, a second region, a third region, and a fourth region.

Operation 504, the second device calculates a first average difference of pixels between the first region and the second region and a second average difference of pixels between the third region and the fourth region.

It can be understood that the operations 501 to 504 are similar to operations 401 to 403 in FIG. 4, and operations 401 to 403 have been described in detail in FIG. 4, and thus related description will not be repeated here.

Operation 505, in responding to that the first average difference of pixels reaches a first preset value, the second device sends a first coordinate recording instruction to the first device.

Operation 506, the first device records first location coordinates according to the first coordinate recording instruction.

Operation 507, in responding to that the second average difference of pixels reaches a second preset value, the second device sends a second coordinate recording instruction to the first device.

Operation 508, the first device records second location coordinates according to the second coordinate recording instruction.

It can be understood that operations 505 to 508 are similar to the operations of recording location coordinates in FIG. 1 and FIG. 4, which have been described in detail in FIG. 1 and FIG. 4 and will not be repeated here.

Operation 509, the first device determines a width of a viewpoint corresponding to the first device according to the first location coordinates, the second location coordinates, and an application angle of the grating corresponding to the first device.

It can be understood that operation 510 is similar to operation 104 in FIG. 1, which has been described in detail in FIG. 1 above, and details are not repeated here.

It should be noted that, in each of the above embodiments, the width of the viewpoint corresponding to the first device is calculated by the first device according to the first location coordinates, the second location coordinates and the application angle of the grating. In another embodiment, after the first location coordinates and the second location coordinates are recorded, the first device sends the first location coordinates and the second location coordinates to the second device, and the second device calculates the width of the viewpoint corresponding to the first device according to the first location coordinates, the second location coordinates and the application angle of the grating corresponding to the first device, and sends the width of the viewpoint corresponding to the first device to the first device. Furthermore, the analyzing of the first group of images and the second group of images to obtain the average differences of pixels can be undertaken by the first device, which are not limited here.

It should also be noted that the calculation of the average difference of pixels, the calculation of the locations and the calculation of the width of the viewpoint have been described in detail with reference to FIGS. 1 to 5, and the calculation of the average differences of pixels, the calculation of the locations and the calculation of the width of the viewpoint here are performed in the same way as those of FIGS. 1 to 5, but by different undertakers, thus details of which are not repeated here.

The embodiments of the present application are described above from the perspective of the method for determining the width of the viewpoint, and will be described below from the perspective of a device for determining widths of viewpoints. The device for determining the width of the viewpoint includes a first device 600 and a second device 700.

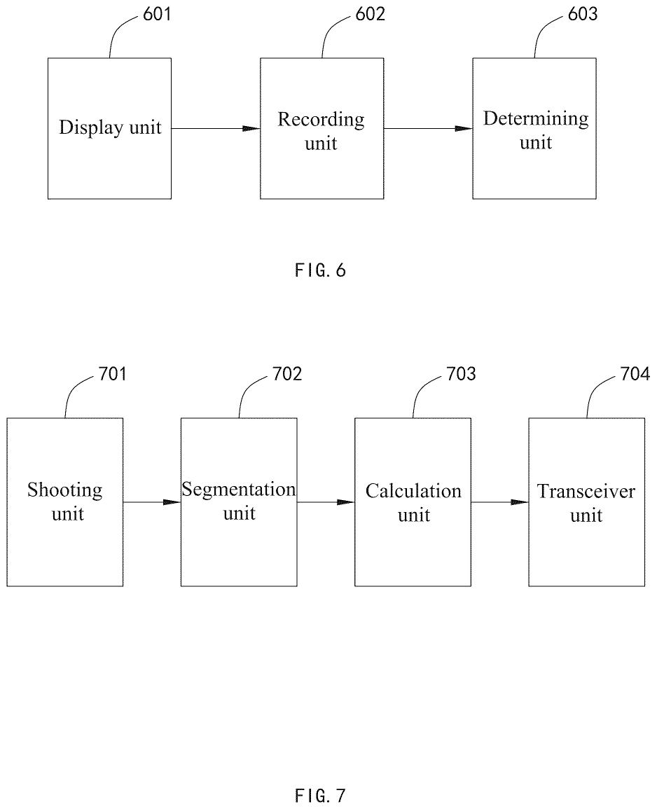

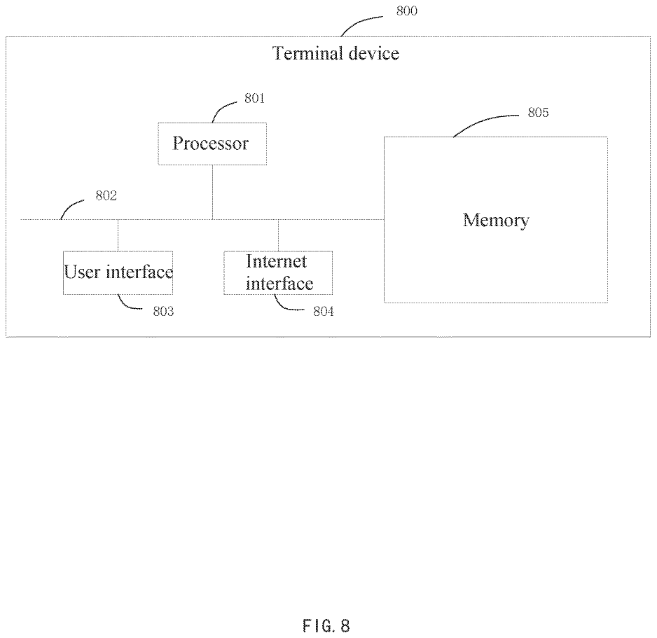

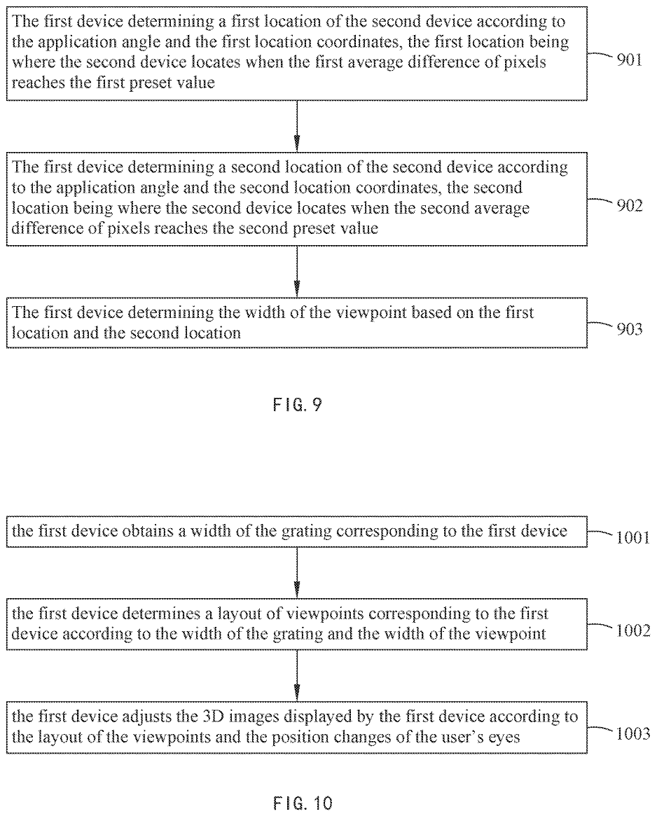

Referring to FIG. 6, FIG. 6 is a schematic diagram of a virtual structure of a first device provided in an embodiment of the present application. The first device 600 includes:
a display unit 601, configured to display a target image in a stereoscopic mode for the second device to shoot in real time to obtain a first group of images and a second group of images, segment two images of the first group of images and two images of the second group of images to obtain a first region, a second region, a third region and a fourth region, and calculate a first average difference of pixels between the first region and the second regions and a second average difference of pixels between the third region and the fourth region, the first group of images and the second group of images being obtained by the second device which shoots, at different locations, the target image through synchronous shooting of two cameras of the second device, the two cameras of the second device being on the same horizontal line, and centers of the two cameras of the second device being spaced away for a preset distance, the first region and the second region corresponding to the two images of the first group of images, and the third region and the fourth region corresponding to the two images of the second group of images;
a recording unit 602, configured for the first device to record first location coordinates where the second device captures the first group of images in responding to a first coordinate recording instruction received from the second device by the first device, and record second location coordinates where the second device captures the second group of images in responding to a second coordinate recording instruction from the second device by the first device, the first coordinate recording instruction being issued in responding to that the first average difference of pixels reaches a first preset value, and the second coordinate recording instruction being issued in responding to that the second average difference of pixels reaches a second preset value;
a determining unit 603, configured to determine a width of a viewpoint corresponding to the first device according to the first location coordinates, the second location coordinates, and an application angle of the grating corresponding to the first device.

Referring to FIG. 7, FIG. 7 is a schematic diagram of a virtual structure of the second device provided in an embodiment of the present application. The second device 700 includes:
a shooting unit 701, configured to shoot in real time a target image displayed by the first device in stereoscopic mode to obtain a first group of images and a second group of images, the first group of images and the second group of images being obtained by the second device which shoots, at different locations, the target image through synchronous shooting of two cameras of the second device, and the two cameras of the second device being on the same horizontal line, and centers of the two cameras being spaced away for a preset distance;
a segmentation unit 702, configured to segment two images in the first group of images and two images in the second group of images to obtain a first region, a second region, a third region and a fourth region, the first region and the second region corresponding to the two images in the first group of images, and the third region and the fourth region corresponding to the two images of the second group of images;
a calculation unit 703, configured to calculate a first average difference of pixels between the first region and the second region and a second average difference of pixels between the third region and the fourth region;
a transceiver unit 704, configured to send a first coordinate recording instruction to the first device in responding to that the first average difference of pixels reaches a first preset value, to cause the first device to record a first coordinate location, send a second coordinate recording instruction to the first device in responding to that the second average difference of pixels reaches a second preset value, to cause the first device to record second location coordinates and determine a width of a viewpoint corresponding to the first device according to the first location coordinates, the second location coordinates and an application angle of a grating corresponding to the first device, the first location coordinates are coordinates of a location of the second device when taking the first group of images and the second location coordinates are coordinates of another location of the second device when capturing the second group of images.

Finally, it should be noted that the above embodiments are only used to illustrate the technical solutions of the present application, and are not intended to limit the present application. Although the present application has been described in detail with reference to the foregoing embodiments, those of ordinary skill in the art should understand that those embodiments can be modified, or some or all of the technical features can be equivalently replaced, and those modifications or replacement do not deviate from the essence of the corresponding embodiments.

1. A method for determining widths of viewpoints, comprising:
displaying, by a first device, a target image in a stereoscopic mode, for a second device to shoot the target image in real time to obtain a first group of images and a second group of images, and divide two images in the first group of images and two images in the second group of images to obtain a first region, a second region, a third region and a fourth region, and calculate a first average difference of pixels between the first region and the second regions and a second average difference of pixels between the third region and the fourth region, the first group of images and the second group of images being obtained by the second device which shoots, at different locations, the target image through synchronous shooting of two cameras of the second device, the two cameras of the second device being on a same horizontal line, and centers of the two cameras of the second device being spaced away for a preset distance, the first region and the second region corresponding to the two images of the first group of images, and the third region and the fourth region corresponding to the two images of the second group of images;
recording, by the first device, first location coordinates at which the second device captures the first group of images, in responding to a first coordinate recording instruction received by the first device from the second device, the first coordinate recording instruction being issued in responding to that the first average difference of pixels reaches a first preset value;
recording, by the first device, second location coordinates at which the second device captures the second group of images, in responding to a second coordinate recording instruction received by the first device from the second device, the second coordinate recording instruction being issued in responding to that the second average difference of pixels reaches a second preset value;
determining, by the first device, a width of a viewpoint corresponding to the first device according to the first location coordinates, the second location coordinates and an application angle of a grating corresponding to the first device.

2. The method according to claim 1, wherein the determining, by the first device, the width of the viewpoint corresponding to the first according to the first location coordinates, the second location coordinates, and the application angle of the grating corresponding to the first device comprises:
determining, by the first device, a first location of the second device according to the application angle and the first location coordinates, the first location being where the second device locates when the first average difference of pixels reaches the first preset value;
determining, by the first device, a second location of the second device according to the application angle and the second location coordinates, the second location being where the second device locates when the second average difference of pixels reaches the second preset value; and
determining, by the first device, the width of the viewpoint based on the first location and the second location.

3. The method according to claim 2, wherein,
the first location is calculated according to a formula:
$${X}_{0}^{′} = {x}_{0} + ( {y}_{0} - y ) * tan ( a )$$
wherein
$${X}_{0}^{′}$$
represents the first location, the first location coordinates are (x₀, y₀), y is a preset constant, and a is the application angle.

4. The method according to claim 3, wherein,
the second location is calculated according to a formula:
$${X}_{1}^{′} = {x}_{1} + ( {y}_{1} - y ) * tan ( a ) ;$$
wherein
$${X}_{1}^{′}$$
represents the second location, and the second location coordinates are (x₁, y₁).

5. The method according to claim 4, wherein,
the width of the viewpoint is calculated according to a formula:
$$VW = abs ( {X}_{0}^{′} - {X}_{1}^{′} ) ;$$
wherein VW represents the width of the viewpoint corresponding to the first device, and abs is an absolute value function.

6. The method according to claim 1, further comprising:
obtaining a width of the grating;
determining a layout of viewpoints corresponding to the first device according to the width of the grating and the width of the viewpoint; and
adjusting 3D images displayed in the stereoscopic mode according to the layout of the viewpoints and change in position of a user's eyes.

7. A method for determining widths of viewpoints, comprising:
shooting in real time, by a second device, a target image displayed in stereoscopic mode by a first device, to obtain a first group of images and a second group of images, the first group of images and the second group of images being obtained by the second device which shoots, at different locations, the target image through synchronous shooting of two cameras of the second device, and the two cameras of the second device being on a same horizontal line, and centers of the two cameras being spaced away for a preset distance;
segmenting, by the second device, two images in the first group of images and two images in the second group of images to obtain a first region, a second region, a third region and a fourth region, the first region and the second region corresponding to the two images in the first group of images, and the third region and the fourth region corresponding to the two images of the second group of images;
calculating, by the second device, a first average difference of pixels between the first region and the second region and a second average difference of pixels between the third region and the fourth region;
sending, by the second device, a first coordinate recording instruction to the first device in responding to that the first average difference of pixels reaches a first preset value, to cause the first device to record first location coordinates, the first location coordinates being coordinates of a location of the second device when capturing the first group of images;
sending, by the second device, a second coordinate recording instruction to the first device in responding to that the second average difference of pixels reaches a second preset value, to cause the first device to record second location coordinates and determine a width of a viewpoint corresponding to the first device according to the first location coordinates, the second location coordinates and an application angle of a grating corresponding to the first device, the second location coordinates being coordinates of another location of the second device when capturing the second group of images.

8. The method according to claim 7, wherein,
the first average difference of pixels is calculated according to a formula:
$$aver\_pixel = {\sum }_{j = 0}^{w} {\sum }_{j = 0}^{h} abs ( Al ( i , j ) - Ar ( i , j ) ) / ( w * h )$$
wherein aver_piexl represents the first average difference of pixels, Al represents the first region, Ar represents the second region, w is a width of the first region, h is a height of the first region, the first region and the second region are identical both in width and height;
the second average difference of pixels is calculated according to a formula:
$$aver\_pixel = {\sum }_{j = 0}^{w} {\sum }_{j = 0}^{h} abs ( Al ( i , j ) - Ar ( i , j ) ) / ( w * h )$$
wherein aver_piexl represents the second average difference of pixels, Al represents the third region, Ar represents the fourth region, w is a width of the third region, h is a height of the third region, the third region and the fourth region are identical both in width and height.

9. A device for determining widths of viewpoints, comprising a first device, wherein the first device comprises:
a display unit, configured to display a target image in a stereoscopic mode for the second device to shoot in real time to obtain a first group of images and a second group of images, segment two images of the first group of images and two images of the second group of images to obtain a first region, a second region, a third region and a fourth region, and calculate a first average difference of pixels between the first region and the second regions and a second average difference of pixels between the third region and the fourth region, the first group of images and the second group of images being obtained by the second device which shoots, at different locations, the target image through synchronous shooting of two cameras of the second device, the two cameras of the second device being on the same horizontal line, and centers of the two cameras of the second device being spaced away for a preset distance, the first region and the second region corresponding to the two images of the first group of images, and the third region and the fourth region corresponding to the two images of the second group of images;
a memory, configured for storing program codes; and
a processor, configured for running the program codes from the memory to:
record first location coordinates where the second device captures the first group of images in responding to a first coordinate recording instruction received from the second device by the first device, and record second location coordinates where the second device captures the second group of images in responding to a second coordinate recording instruction from the second device by the first device, the first coordinate recording instruction being issued in responding to that the first average difference of pixels reaches a first preset value, and the second coordinate recording instruction being issued in responding to that the second average difference of pixels reaches a second preset value; and
determine a width of a viewpoint corresponding to the first device according to the first location coordinates, the second location coordinates, and an application angle of the grating corresponding to the first device.

10. The device according to claim 9, further comprising a second device, wherein the second device comprises:
a shooting unit, configured to shoot in real time a target image displayed by the first device in stereoscopic mode to obtain a first group of images and a second group of images;
a memory, configured to store program codes; and
a processor, configured to run the program codes from the memory to:
segment two images in the first group of images and two images in the second group of images to obtain a first region, a second region, a third region and a fourth region; and
calculate a first average difference of pixels between the first region and the second region and a second average difference of pixels between the third region and the fourth region; and
a transceiver unit, configured to send a first coordinate recording instruction to the first device in responding to that the first average difference of pixels reaches a first preset value, to cause the first device to record first location coordinates, send a second coordinate recording instruction to the first device in responding to that the second average difference of pixels reaches a second preset value, to cause the first device to record second location coordinates and determine a width of a viewpoint corresponding to the first device according to the first location coordinates, the second location coordinates and an application angle of a grating corresponding to the first device, the first location coordinates being coordinates of a location of the second device when taking the first group of images and the second location coordinates being coordinates of another location of the second device when capturing the second group of images.

11. A computer device, comprising:
a memory configured to store program codes; and
a processor configured to call the program codes from the memory to perform the method for determining widths of viewpoints according to claim 1.

12. A computer device, comprising:
a memory configured to store program codes; and
a processor configured to call the program codes from the memory to perform the method for determining widths of viewpoints according to claim 7.

13. A non-transitory storage medium, comprising:
instructions, wherein, when the instructions are run by a computer, the computer is caused to perform the method for determining widths of viewpoints according to claim 1.

14. A non-transitory storage medium, comprising:
instructions, wherein, when the instructions are run by a computer, the computer is caused to perform the method for determining widths of viewpoints according to claim 7.
